(19) United States
(12) Patent Application Publication
(10) Pub. No.: US 2015/0085293 A1
(43) Pub. Date: Mar. 26, 2015

(54) Portable system for simultaneously operating optical far field imaging, tomography and spectroscopy

(71) Applicant: National Cheng Kung University, Tainan City (TW)

(72) Inventors: Wei-Chih WANG, Tainan City (TW); Chih-Han CHANG, Tainan City (TW); Fong-Chin SU, Tainan City (TW)

(73) Assignee: National Cheng Kung University, Tainan City (TW)

(21) Appl. No.: 14/037,600

(22) Filed: Sep. 26, 2013

(51) Int. Cl. G01B 9/02; G02B 21/00; G02B 26/10

(52) U.S. Cl. CPC G01B 9/02091; G02B 26/103; G02B 21/002; G02B 26/101
USPC 356/479; 359/209.1

(57) ABSTRACT

A portable optical tomography design for performing elastographic deformation mapping of tissues comprises a coherence light source providing one light beam; a scanning microscope comprising a waveguide having two terminals, a coupler disposed on one terminal, an actuating member connected to the waveguide or the coupler, a first optical reflection member, a beam splitter, and a Fourier-domain spectrometer. The waveguide is actuated by the actuator to traverse a horizontal and vertical motion to prescribe a two-dimensional plane for scanning the tissue sample. Optical fiber is used to connect above elements therebetween. The Fourier-domain spectrometer is coupled with the beam splitter and comprises a second reflection member and an interferogram capturing member. An interferogram produced from the Fourier-domain spectrometer is carried over to a digital signal processor and subsequently an optical coherence tomography image device to generate a three-dimensional image for the scanned tissue.

### FIELD OF INVENTION

The present invention relates generally to optical imaging, and more particularly to an optical tomography system having a compact sized scanning microscope and spectrometer for performing optical scanning of a sample.

### BACKGROUND OF THE INVENTION

Tomography is a fairly well-known signal acquisition and processing method, which has long been known to take measurements around the periphery of an object to study the mechanical and chemical organization inside the object. Some of the best known applications of tomography are medical in nature, including CAT scanning, magnetic resonance imaging, and positron emission tomography.

In optical tomography, the general approach is to rely on a low coherence source (LCS), a beam splitter (BS), and a reference mirror (REF) to provide a light source to be directed onto a biological tissue sample. The light source emits a beam that passes through the beam splitter, usually by coupling the light into a 2×2 fiber coupler, directing the resultant beams down two separate fibers, one to the reference mirror and the other to the biological tissue sample. A microlens disposed at the end of the fiber proximal to the biological tissue sample would transmit the light reflected off the biological tissue sample back to the beam splitter for recombination with the light coming back from the reference mirror. The recombined light would yield an interferogram and is subsequently output to another fiber of the coupler to be read by a spectrometer system, from where the interferogram is analyzed by a digital signal processing unit to generate three-dimensional images of the scanned biological tissue sample.

In traditional medical tomography devices, microscopy and spectroscopy provide two important components for sample characterization. While these two techniques are usually performed on an individual basis, they are often performed simultaneously to provide electrical signals for medical image generation. A problem common to today's design in this regard is that these two pieces of equipment are often bulky and not easy to carry around.

In this regard, technological advancements in endoscopy design are being developed due to the increased demand for minimally invasive medical procedures (MIMPs). One such advancement is reducing the overall size of endoscope systems while increasing their resolution and field-of-view. Reduction of size promises less tissue damage and trauma during operation as well as shorter recovery times for patients. In addition, current developments have called for new endoscope designs with improved accessibility to parts of the human body currently unreachable by conventional endoscopes. This design seeks to meet these challenges by offering cheaper, more portable, and robust solution.

A feature with the use of the portable OCT device is that when it is in use, there is no need to reposition the biological tissue sample in order for it to be aligned with the OCT device because the repositioning can be waived due to the benefit effected by OCT's portability. See EP 1928297 A1. It is also known in this prior art to assemble at least one mirror to scan in at least two directions, an OCT probe having a relay lens set coupled to the at least one mirror. However, it is not disclosed or obvious for a full-field scanning probe and the probe in this case is not inclusive of a waveguide addition for collecting source light.

Fourier-domain OCT devices with improved instrumentation properties are also known in the public domain of knowledge to cover alignment sensitivity, portability, or simplification of the mechanical structure. For example, EP 1812772 A2 discloses a miniature Fourier transform spectrometer for determining the light absorption/transmission spectra of a collected sample of gas or liquid through Fourier transform spectroscopy techniques. It comprises a substrate, a Michelson interferometer comprising a cube beam splitter monolithically integrated with an optical path length modulator and a stationary mirror, and a detector. EP 1677086 A1 discloses a binary grating based Fouirer transform spectrometer with variable grating. The device comprises a first set of mirrors and a second set of mirrors, and further comprises an actuator for prompting a motion of the second set of mirrors and a detector for detecting a radiation reflected by the grating.

However, there remains room for improvement on reducing setup complexity and increasing precision, which may involve using components for the scanning probe that collects reflected light data from a sample and delivers the measured light information to the spectrometer.

### BRIEF SUMMARY OF THE INVENTION

Embodiments of the present invention provide an optical tomographic imaging system having an actuator embedded in a housing that measures interference of a reference light and a sample-reflected light. A Fourier-transform detector coupled to the actuator in the microscope, for example, an endoscope of a desired portable size, can work to perform signal-to-noise ratio calculation for subsequent three dimensional image computations.

An aspect of the invention is directed to a scanning system for performing a non-invasive diagnosis in which interference of a light reflected off a sample and a light from a reference source is correlated to strain in soft tissue to detect internal fluid flow or structural organization. The system is a miniaturized, integrated micro scanning system with its dimension size being less than 1 mm in diameter. Components are designed to incorporate endoscopes for far field imaging and for optical coherent tomography to obtain images and tissue characterization on a scale previously impossible inside a human body.

The general advantages of this system are fourfold: first, deployment of this image acquisition device will lead to low cost optical scanners and create a new class of diagnostic medical imaging technology. Two, a reduction in diameter and size will increase extent of accessibility of the optical tomographic device, enable users to examine areas unreachable by currently available endoscopes, and enable both confocal and full-field tomographic scanning. Third, the system can reduce undesirable damage to surrounding tissue under examination. Fourth, it is possible for integration of imaging with other functional devices such as diagnostic and therapy devices. Therefore, it will be understood that the many applications of the current invention can find use in settings such as biology, biomedicine, and others not limited for the circumstances as presently described in this disclosure.

Another aspect of the current invention is a method for implementing a three-dimensional imaging based optical tomography system. In this aspect, a low coherent light passes through a beam slitter, such as a 2×2 fiber coupler, to split into multiple beams of light. Focusing the light beam to a point on the surface of a sample, and recombining the reflected light with a reference will produce an interferogram containing information about the sample. The interferogram is delivered to the beam splitter, which then transmits the information as a single beam of light to the spectrometer. In particular for preferred embodiment of the current invention, the scanning endoscope is capable of performing one- and two-dimensional scanning for the time domain OCT, and is designed in a compact size to fit into a tubular or any desirable shape housing for required maneuverability. In addition, a single-mirror spatial interference Fourier transform spectrometer is used in a preferred embodiment in place as a spectrometer, which is capable of generating a spatially-distributed interference pattern from a collimated monochromatic or broadband light source onto a CCD camera for detection and analysis. In frequency domain OCT, the broadband interference is acquired with spectrally separated detectors. The present invention uses a Fourier transform spectrometer using spatial interference to acquired the broadband interference. Based on the theory of the Wiener-Khintchine theorem stating that the power spectral density of a wave defined by a wide-sense-stationary random process is the Fourier transform of the autocorrelation of the wave defined by the wide-sense-stationary random process, the depth scan going below the surface of the biological tissue can be instantly calculated by a Fourier-transform from the acquired spectra, without movement of the reference arm. This feature improves imaging speed dramatically, while the reduced losses during a single scan improve the signal to noise proportional to the number of detection elements.

Yet another preferred aspect of the current invention is a laparoscope-like movable head catheter scope. The apparatus comprises a catheter composed of a waveguide, a lens that is mounted on one end of the waveguide, a coupler attached on another end of the waveguide, and an actuator comprising multiple actuating pads pivotally attached to a section on the waveguide through a rotating arm. Due to the minimal number and size of components, the device will be a minimally invasive tool for intravascular insertion in human body, and therefore is capable of minimally-invasive medical imaging of atherosclerotic disease and thrombus problems when inserted into the veins.

Additionally, the push-pull mechanism operable on the actuator can work to enable up to a two-dimensional scanning space. The electrically or magnetically activated pads on the actuator will, depending on the user's actions or programmed behavior, elongate or contract as well as twist and turn to generate two dimensional motion of the waveguide cantilever.

These and other features and benefits of the current invention will become apparent to those persons skilled in the art in view of the following description of the specific embodiments.

### BRIEF DESCRIPTION OF THE DRAWINGS

FIG. 1 is a general configuration of a portable optical tomography system according to the current invention.

FIG. 2 is a perspective view showing a Fourier-domain spectrometer for the current invention.

FIG. 3 is an isometric schematic view of a scanning microscope enclosed in a housing according to the current invention.

FIG. 4 shows a waveguide and a coupler connected to an actuating member according to an embodiment of the current invention.

FIG. 5 is shows a waveguide having a lens assembly disposed on a terminal of the waveguide according to an embodiment of the current invention.

FIG. 6 is a cross section of a rib waveguide structure for the scanning microscope according to an embodiment of the current invention.

### DETAILED DESCRIPTION OF THE INVENTION

More detailed description of the invention will be provided below, reference is made to the accompanying drawings which form a part of the disclosure, and in which exemplary embodiment by which the invention may be practiced. It should be understood that the present invention is not limited to the embodiments described and illustrated herein, but can extend to other embodiments, as would be known or as would become known to those skilled in the art.

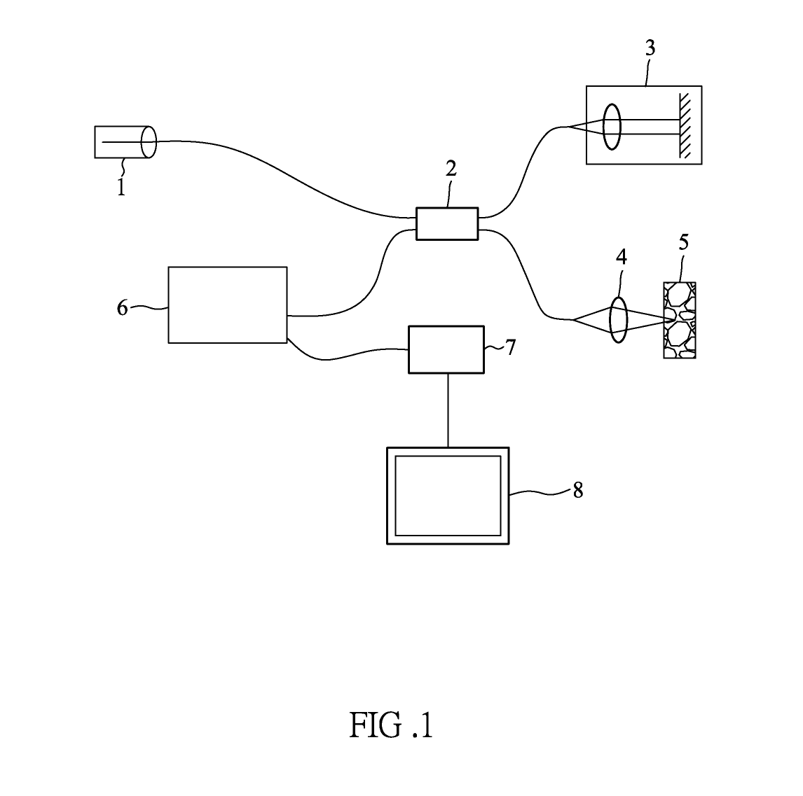

FIG. 1 shows a general configuration of a portable optical tomography system according to the current invention, in which the setup shows a coherence light source 1 coupled to a beam splitter 2 to provide a light source. The beam splitter 2 is, on its other end, connected to a first optical reflection member 3.

The light source 1 provides a beam of light, which has a wavelength from a range of 750 nanometers to 1600 nanometers. In a preferred embodiment, the wavelength range is between 780 nanometers and 1570 nanometers. Also, the light source 1 can be one selected from the group consisting of light emitting diode, superluminescent diode, fiber amplifier device, femtosecond pulse laser device, and a combination thereof. In a preferred embodiment, the light source is a laser diode.

The beam splitter 2 can be designed in any way as desired as long as it splits a beam of light in at least two. In the current case, it is preferred to be a 2×2 fiber coupler.

It will be understood to an average person having skilled knowledge that the first optical reflection member 3 here is an element used as a reference in an optical interference undertaking, it is not restricted to any particular setup, as it can vary as required to accommodate different purposes. For example, a combination of a single planar mirror and a light beam converging lens may be coupled together to serve as part of the first optical reflection member 3 setup to reflect an incident light beam and focus the reflected light beam for subsequent use. Also, the beam splitter 2 is coupled to a scanning microscope 4, which operates to scan a tested sample 5. During optical coherence tomography imaging, the first optical reflection member 3 is scanned at a constant velocity, permitting generation of depth scans. The two dimensional scanner 4 driven by a two dimensional actuator will scan across the entire tissue sample 5 area to build three-dimensional images in a pixel by pixel fashion. The scanning microscope 4 works to shine a beam of light onto the sample 5 and receives reflected light off the sample 5. The scanning microscope 4 in the current invention is designed to be of a minimized size that is compact and easy to operate without compromise to light wave propagation.

Because the broadband light source 1 has a short coherence length, only light which has traveled very short distance to the same time (or optical path length) in the first optical reflection member 3 and tissue sample 5 will interfere constructively and destructively. By changing the length of the first optical reflection member 3, reflected signals from different depths within the tissue sample 5 can be sampled. The depth resolution of the optical coherence tomography system is determined by the effectiveness of this time gating and hence is inversely proportional to the bandwidth of the source. An optical detector in the final arm of the Michelson interferometer detects the interference between the first optical reflection member 3 and tissue signals. The detected interference fringe signal is demodulated using bandpass filtering and envelope detection. The demodulated signal is then digitized and stored in a computer. In an alternative mode, the bandpass filter and envelope detection can be replaced by a Fourier-transform spectrometer system (or FTS unit; also known as Fourier domain spectrometer).

In an embodiment of the current invention, the reflected light off the sample 5 is directed back to the beam splitter 2 to be then sent to a Fourier-domain spectrometer 6 to undergo light interference. The reflected light, which contains information about the sample 5 under study, is processed in the Fourier-domain spectrometer 6 and next directed to a digital signal processor 7, which takes in the outbound light from the Fourier-domain spectrometer 6 and transforms the light signal into a digital signal. The digital signal produced therefrom is transmitted to an optical coherence tomography image producer 8.

All constituting elements of the current invention except the digital signal processor 7 and the optical coherence tomography image producer 8 are coupled to their respective connected counterpart by a waveguide material, and the waveguide material is not particularly restricted. In a preferred mode, the waveguide material is an optical fiber. The digital signal processor 7 and the optical coherence tomography image producer 8 are connected by an electrically conductive means, for example an electrical wire.

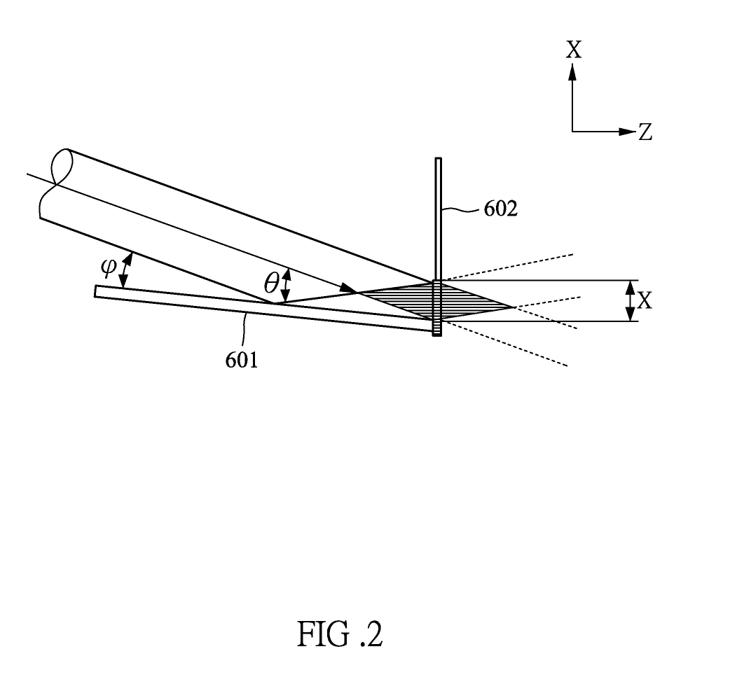

Referring now to FIG. 2, a Fourier-domain spectrometer 6 of the current invention is shown. The Fourier-domain spectrometer 6 comprises a second reflection member 601 and an interferogram capturing member 602.

In more specific terms, the FTS unit 6 operates to receive an interferogram from the beam splitter 2. The interferogram can come in the form of a collimating monochromatic or broadband light. As shown in FIG. 2, the FTS unit 6 comprises a single mirror for causing phase shift of the incidence light to part into two beams of light with different phases; the singe mirror is set up in such a way that a first beam of the two arrives at the mirror before the other, causing the first beam to reflect and cross in its new travel direction with a second beam that has not reached the mirror. The intersection of the two beams leads to formation of optical interference. The spacing of the interference depends on the optical path length, the angle between the two converging beams (θ), and the wavelengths (λ). The single mirror setup shown in FIG. 2, demonstrates how interference is created using only a single beam and a single mirror. The interference fringes of spatial frequency are formed when a plane wave front is spatially divided in half by a plane mirror, with the halves superimposed when they converge on a interference pattern capturing member. On this, a charge-coupled device camera (CCD camera), or any other device capable of moving electrical charge, can be used as a capturing member to capture the interference pattern.

In an embodiment of the invention for the aspect of the Fourier-transform spectrometer, the CCD camera is a preferred interference pattern capturing member. Furthermore, the resolution of the CCD is vital for anti-aliasing, which, in other words, means that the highest frequency (or the shortest wavelength) that can be resolved is limited by the linear CCD array resolution (pixel density). This limitation can easily be resolved by placing a lens in front of the linear CCD array to magnify the interferogram.

In another embodiment of the invention, the intersecting angle formed between the interferogram capturing member 602 and the second reflection member 601 is configured in such a way to allow most recognizable generation of interference pattern subject to real-time response from the testing environment.

In the current embodiment, the second reflection member 601 and the interferogram capturing member 602 are substantially arranged at an angle between 89.5° and 90°. In more details, when a reflected light is transmitted to the Fourier-domain spectrometer 6, a portion of the incident light would arrive at the second reflection member 601 before another portion of the incident light arrives at the second reflection member 601. An angle included by the incident light that is the first to arrive at the second reflection member 601 is designated by φ. An angle included by the incident light that is the second to arrive at the second reflection member 601 is marked by θ. The first-arriving light portion that is reflected off the second reflection member 601 and the second-arriving light portion that is reflected off the second reflection member 601 cross each other to produce an interferogram marked by a lined area designed by X. The interferogram X is recorded by the interferogram capturing member 602, which then records and send the interferogram out of the Fourier-domain spectrometer 6 for further processing.

The interferogram capturing member 602 can be a charge-coupled device or a CMOS sensor.

The imaging will be performed using a OCT imaging system, also switchable through optical connections. Since the principle OCT is white light or low coherence interferometry, the optical setup typically consists of an interferometer with a low coherence, broad bandwidth light source.

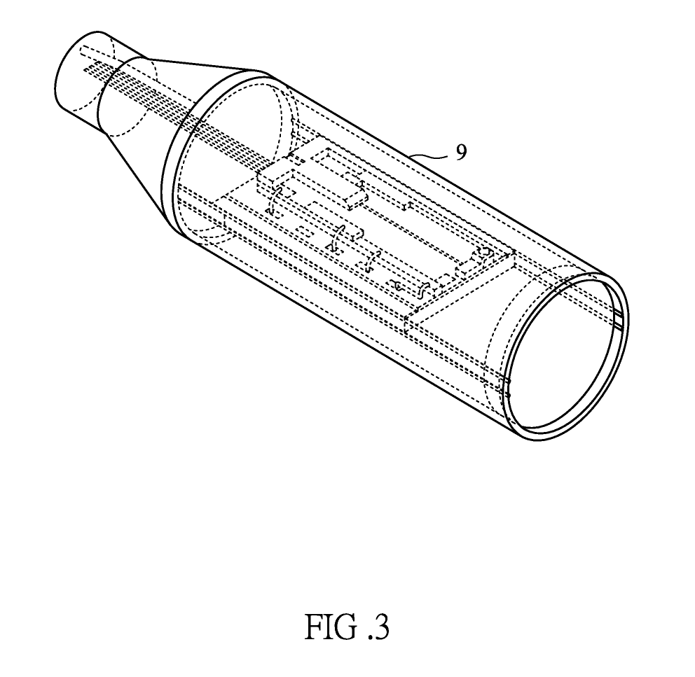

In reference to FIG. 3, a waveguide 401 is shown to be installed in a housing 9 for an embodiment of the current invention. The housing 9 is configured in such a way to allow mechanically or electrically activated mechanism. When activated, the pads will elongate or contract as well as twist and turn to realize a two-dimensional movement to the waveguide cantilever. In another embodiment, the housing 9 has a circular geometry having a tapered end. The tapered end of the housing 9 is formed to have a diameter smaller than the diameter of another tip of the housing 9, such that the housing 9 is easy for hand or machine maneuvering.

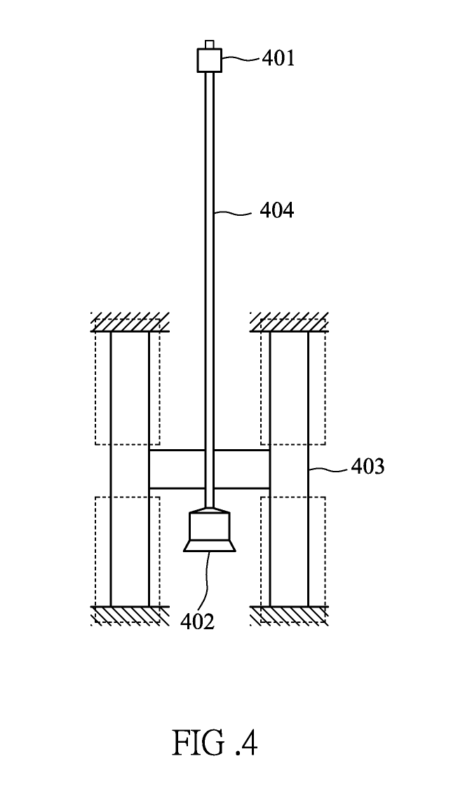

FIG. 4 shows a waveguide and a coupler connected to an actuating member according to an embodiment of the current invention. In the current embodiment, the waveguide is constructed to be a bead-like module, disposed on a tip of a connecting member 4. The connecting member 4, in this case, is a long and straight stick, but is not particularly restricted to this design. On another end of the connecting member 4 is disposed with a coupler 402, for connecting with an optical fiber. Furthermore, an actuating member 403 is attached onto the connecting member 4, the actuating member 403 in this case comprises four actuating pads. The design choice for the actuating member 403 is not particularly limited to four actuating pads, as long as it can enable the waveguide to traverse a horizontal direction and a vertical direction to prescribe said two-dimensional plane area. For example, to further elaborate the current embodiment, the actuating pads 403 are attached on evenly distributed on two sticks parallel to the connecting member 404, which are connected to the connecting member 404 through a stick perpendicular to the connecting member 404.

The actuating member 403 can be made of a MEMS material, and is made of a material selected from the group consisting of piezoelectric, electrostatic, and electromagnetic material. A preferred embodiment for this regard is the piezoelectric material, particularly thin film PZT.

In another example, which is not shown in the figures, the actuating member 403 is directly connected to the waveguide 404 instead of to a connecting member 404.

Additionally, he way the actuating member 403 is attached to either the waveguide 401 or the connecting member 404 can be pivotal, slidable, or retractable.

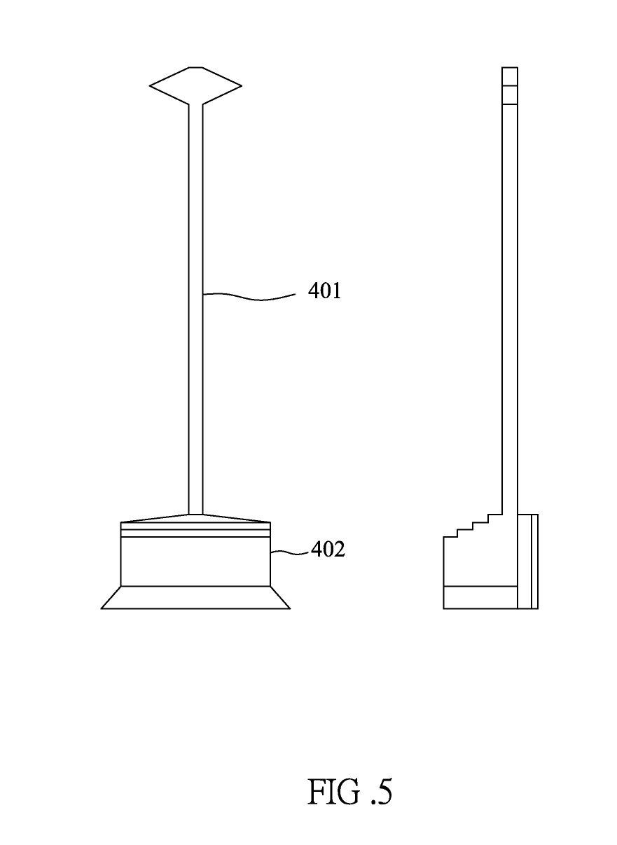

FIG. 5 shows a waveguide having a lens assembly disposed on a terminal of the waveguide according to an embodiment of the current invention. In an embodiment of the scanning microscope, for the purpose of increasing the coupling efficiency between the input fiber and the scanning waveguide, the waveguide structure can be designed near the input end of the scanning waveguide to include a tapered structure. More particularly, the tapered section is to connect a uniform cross section cantilever beam where the tip is designed to be a diamond shape to lower the natural frequency of the structure. The diamond shape structure of the waveguide can eventually be replaced by a SU-8 polymer based lens that is directly fabricated at the end of the waveguide.

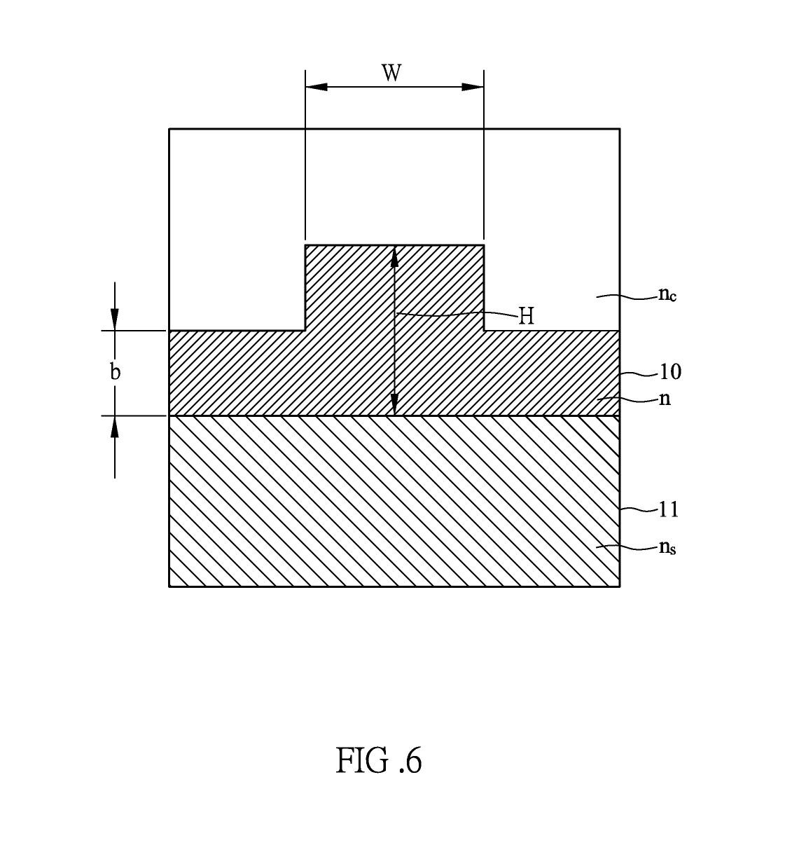

FIG. 6 is a cross-sectional view of the waveguide composition, which comprises a photoresist layer 102 on a substrate 11. In the present embodiment, the substrate is preferred to be silicon oxide (SiO₂). The structural example of the waveguide is not particularly limited; it can be of a rib-like structure as shown here. As can be seen, the structure of the waveguide is presented to be T shaped (that is, rib). The wavelength range can be from 750 nm to 900 nm, preferable for application in confocal endoscopy. In this case, the photoresist layer 102 has a higher plateau defined by a height of H and a lower plateau defined by a height of b, n_{c} is the index of refraction for gas, n is the index of refraction for photoresist, and nₛ is the index of refraction for the substrate. For reference, the refractive index for air is 1, the refractive index for silicon oxide is 1.45.

Since the optical power collected by the photodetector (that is, the Fourier-transform spectrometer in the current invention or the endoscopic micro scanner) is the product of the light intensity at the detector and the area of the detector, the output power of the light leaving the photodetector can be affected by the design of the photodetector. Furthermore, light power is essential to create the final imaging product, design consideration is important for needs of the current invention.

Therefore, consideration must be made to the geometry of the composition of a waveguide as they have important effect on light reflection inside the waveguide and ultimately the output light leaving the waveguide.

The size dimension design of the rib structure, the design parameters can be based on the single mode conditions proposed by Soref, as the following:

$$\begin{matrix}\frac{H}{λ} \sqrt{{n}_{f}^{2} - {n}_{s}^{2}} \geq 1 & ( 1 ) \\ 0.5 \leq r ≡ \frac{h}{H} < 1 & ( 2 ) \\ \frac{a}{b} = \frac{w}{H} \leq ( \frac{q + 4 π b}{4 π b} ) \frac{1 + 0.3 \sqrt{{( \frac{q + 4 π b}{q + 4 π rb} )}^{2} - 1}}{\sqrt{{( \frac{q + 4 π b}{q + 4 π rb} )}^{2} - 1}} & ( 3 )\end{matrix}$$

q is defined as:

$$q = \frac{{γ}_{c}}{\sqrt{{n}_{f}^{2} - {n}_{c}^{2}}} + \frac{{γ}_{s}}{\sqrt{{n}_{f}^{2} - {n}_{s}^{2}}} \qquad ( 4 )$$

where γ_{c}=γₛ=1 for TE modes,

$${γ}_{c} = \frac{{n}_{c}^{2}}{{n}_{f}^{2}}$$

$$and$$

$${γ}_{s} = \frac{{n}_{s}^{2}}{{n}_{f}^{2}}$$

for TM modes.

Size dimension of the waveguide, as shown in Table 1 below, can be understood to show a output power greater than 90% if it is to be obtained from a combination of a slab height/waveguide height ratio of 0.5, width of 8 μm, guiding layer height of 8.6 μm, slab height of 4.3 μm. As such, assuming the geometric height ratio between the lower plateau (h) and the higher plateau (H) is held constant at 0.5 for an optimal design purpose for an embodiment of the present invention, a preferred example of the current invention is presented in Case 1 for the dimension of the waveguide, the output power of such can be seen to be greater than 90%.

TABLE 1
Output power as a function of waveguide
geometry (geometry unit: μm)

| | | | | | Center | Output |
|---|---|---|---|---|---|---|
| | R | W | H | h | of input | power |
| Case 1 | 0.5 | 8 | 8.6 | 4.3 | 4.3 | >90% |
| Case 2 | 0.5 | 5 | 5.2 | 2.6 | 2.6 | ~87% |
| Case 3 | 0.5 | 3 | 2.9 | 1.45 | 1.45 | ~61% |

Therefore, it can be seen from the above that the current invention provides an optical tomography system that can keep down the occupancy volume without having to considerably compromise the output power of interferogram for generating a three-dimensional image of the biological tissue sample.

With regard to the material making up the waveguide, the waveguide can be made of a polymer-based negatively tone photoresist selected from the group consisting of SU-8, PMMA, and PMGI. In a preferred embodiment, the waveguide is made of SU-8.

In the description, numerous details are set forth for purposes of explanation in order to provide a thorough understanding of the present invention. However, it will be apparent to one skilled in the art that not all of these specific details are required in order to practice the current invention. In addition, while specific embodiments have been described in the description disclosure, those of ordinary skills in the art will appreciate that any arrangement that is calculated to achieve the same purpose may be replaced for the specific embodiments disclosed. More particularly, the specification herein is intended to cover any and all adaptations or variations of the present invention, and it is to be appreciated that the terms used in the following claims should not be understood to limit the invention to the specific embodiments disclosed in the specification. Rather, the invention scope is to be determined entirely y the following claims, which are to be understood in accordance with the established doctrines of claim interpretation, along with the full range of equivalents to which such claims are entitled.

What is claimed is:

1. A portable optical tomography system, comprising:
a coherence light source providing at least one light beam;
a scanning microscope, comprising:
a waveguide having at least two terminals;
a coupler disposed on at least one terminal; and
an actuating member connected to the waveguide or the coupler wherein the actuating member operates to control a horizontal motion and a vertical motion of the waveguide to prescribe a two dimensional plane;
a first optical reflection member;
a beam splitter, which is coupled with the scanning microscope and the optical reflection member through optical fiber, and receives the light beam and splits the light beam into multiple light beams; and
a Fourier-domain spectrometer, which is coupled with the beam splitter, and comprises:
a second reflection member; and
an interferogram capturing member, substantially arranged with the single mirror, wherein the second reflection member and the interferogram capturing member are substantially arranged at an angle between 89.5° and 90°.

2. The optical tomography system of claim 1, further comprising a connecting member onto which the waveguide and the coupler are attached, and the actuating member is connected to the connecting member.

3. The optical tomography system of claim 1, further comprising a connecting member onto which the waveguide is attached, and the actuating member is connected to the connecting member.

4. The optical tomography system of claim 1, wherein the actuating member is pivotally, slidably, or retractably connected with the waveguide.

5. The optical tomography system of claim 1, wherein the actuating member comprises multiple actuating pads.

6. The optical tomography system of claim 1, wherein the waveguide is disposed with a lens assembly on the terminal.

7. The optical tomography system of claim 1, wherein the waveguide is made of a polymer-based negatively tone photoresist, selected from the group consisting of SU-8, PMMA, PMGI, and any combination thereof.

8. The optical tomography of claim 1, wherein the beam splitter is a 2×2 fiber coupler.

9. The optical tomography of claim 1, wherein the interferogram capturing means is a charge-coupled device or a CMOS sensor.

10. The optical tomography of claim 1, wherein the waveguide is made of a material selected from the group consisting of piezoelectric, electrostatic, and electromagnetic material.

11. The optical tomography of claim 1, wherein the light beam is of a wavelength from a range of 780 to 1570 nanometers.

12. The optical tomography of claim 1, wherein the coherence light source is one selected from the group consisting of light emitting diode, superluminescent diodes, fiber amplifier device, femtosecond pulse laser device, and a combination thereof.

13. The optical tomography of claim 1, wherein the coherence light source is a laser diode.

14. A scanning microscope comprising:
a waveguide having at least two terminals;
a coupler disposed on at least one terminal; and
an actuating member connected to at least the waveguide or the coupler wherein the actuating member operates to control a horizontal motion and a vertical motion of the waveguide to prescribe a plane.

15. The optical tomography system of claim 13, further comprising a connecting member onto which the waveguide and the coupler are attached, and the actuating member is connected to the connecting member.

16. The optical tomography system of claim 1, further comprising a connecting member onto which the waveguide is attached, and the actuating member is connected to the connecting member.

17. The optical tomography system of claim 13, wherein the actuating member is pivotally, slidably, or retractably connected with the waveguide.

18. The optical tomography system of claim 13, wherein the actuating member comprises multiple actuating pads.

19. The optical tomography system of claim 13, wherein the waveguide is disposed with a lens assembly on the terminal.

20. The optical tomography system of claim 13, wherein the waveguide is made of a polymer-based negatively tone photoresist

21. The optical tomography system of claim 13, wherein the waveguide is selected from the group consisting of SU-8, PMMA, PMGI, and a combination thereof.
